(19) United States
(12) Patent Application Publication
(10) Pub. No.: US 2022/0043948 A1
(43) Pub. Date: Feb. 10, 2022

(54) VALIDATING QUALITATIVE STATES WITH THE CONFLICT RESOLUTION METHOD

(71) Applicant: Palo Alto Research Center Incorporated, Palo Alto, CA (US)

(72) Inventors: John T. Maxwell, III, Santa Clara, CA (US); Matthew Klenk, San Francisco, CA (US); Johan de Kleer, Los Altos, CA (US)

(21) Appl. No.: 16/986,601

(22) Filed: Aug. 6, 2020

(51) Int. Cl. G06F 30/20

(52) U.S. Cl. CPC G06F 30/20; G06F 2111/04

(57) ABSTRACT

A computer simulation includes qualitative values and constraints of a qualitative state. At least some of the constraints include additions of at least some of the qualitative values. The qualitative values are converted to inequalities and equalities. A subset of the original constraints is extracted that represents all of the additions. A conflict resolution method is applied to the inequalities along with the addition constraints. The conflict resolution method makes a tentative assignment of numerical values to the quantitative values and determines consistencies over all of the inequalities and equalities using the tentative assignments. Based on the conflict resolution method determining that the addition constraints reduce to a trivial inconsistency, the qualitative state can be invalidated.

### STATEMENT REGARDING FEDERALLY SPONSORED RESEARCH OR DEVELOPMENT

This invention was made with government support under contract number HR001118C0041 awarded by Defense Advanced Research Projects Agency (DARPA). The government has certain rights in the invention.

### SUMMARY

The present disclosure is directed to validating qualitative states with the conflict resolution method. In one embodiment, qualitative values and constraints of a qualitative state in a computer simulation are determined. At least some of the constraints include additions of at least some of the qualitative values. The qualitative values are converted to inequalities and equalities. A subset of the original constraints is extracted that represents all of the addition constraints. A conflict resolution method is applied to the inequalities along with the addition constraints. The conflict resolution method makes a tentative assignment of numerical values to the qualitative values and determines consistencies over all of the inequalities and equalities using the tentative assignments. Based on the conflict resolution method determining that the addition constraints reduce to a trivial inconsistency, the qualitative state can be invalidated.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is a block diagram of a system according to an example embodiment;

FIG. 2 is a circuit diagram illustrating a qualitative reasoning example according to an example embodiment;

FIG. 3 is a flowchart of a method according to an example embodiment;

and

FIG. 4 is a diagram of an apparatus according to an example embodiment.

### DETAILED DESCRIPTION

The present disclosure is generally related to qualitative reasoning (QR), which is an artificial intelligence (AI) concept. Qualitative reasoning automates reasoning about the continuous world using abstraction into qualitative values as opposed to quantitative values. Qualitative reasoning can play an important role in early stage design, for example. While QR has not been widely applied in engineering tools, simulation languages such as Modelica have been extended to incorporate QR. Generally, QR captures the relevant differences in behavior resulting from significant differences in parameter values.

When a designer runs a simulation to determine if a model will meet a particular requirement, one of two things will happen. One, the model fails to meet the requirement. In this case, QR can inform the designer which parameters to change or if a change in structure is required. Two, the model meets the requirement. In this case, QR can help the designer understand what ranges of parameter values will maintain success, and under what circumstances lead to failures.

In one embodiment, a QR framework abstracts a Modelica model. From this abstraction, an envisioning algorithm generates the set of all possible qualitative behaviors, called an envisionment. In a mathematically sound mapping, the behavior of every Modelica model with same structure of components corresponds to a trajectory in the envisionment. Unlike current QR approaches, Modelica events are specified declaratively as a set of acausal component models and their connections. This confers two advantages: (1) the connected models correspond to the physical structure of the system, and (2) by being declarative and acausal, they are easier to reuse in different contexts.

A QR framework abstracts continuous quantities into intervals bounded by landmarks. For example, the qualitative model of a diode includes a voltage landmark that determines if the diode is “on” or “off”. We capture landmarks using variables with the 3-valued qualitative abstraction corresponding to the sign of the value: e.g., {Q−, Q0, Q+} with Q0 corresponding to the landmark value in this example. The qualitative behavior of a system is a sequence of alternating intervals and instants with an instant whenever a quantity reaches a landmark. The set of all possible behaviors is called an envisionment and is typically represented as a graph. Each node represents a qualitative state (e.g., an assignment of a qualitative value to each variable). Each edge is a successor relation that is determined by constraints on the qualitative values of their quantities.

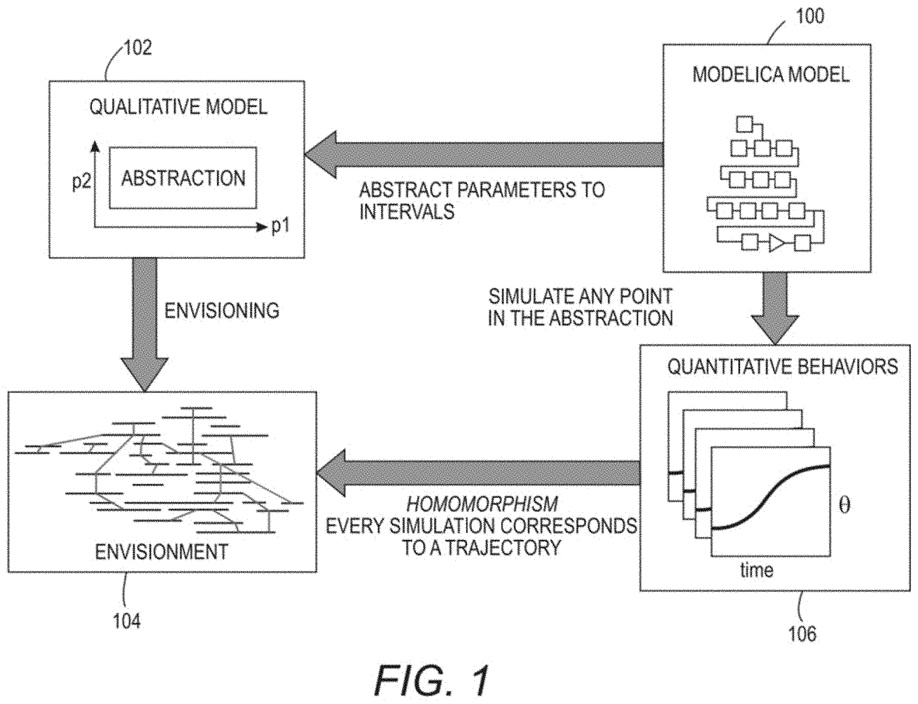

A mathematically sound abstraction of a Modelica model ensures that the results of every quantitative simulation of consistent sets of numeric parameters correspond to a trajectory in the envisionment. This relationship is shown in FIG. 1. Given a Modelica model 100, we create an abstraction consisting of constraints and an initial qualitative model 102 from which we produce an envisionment 104. Every assignment of parameters that is consistent with respect to the Modelica model and the abstraction will result in a quantitative simulation 106, and each correct simulation will correspond to a trajectory in the envisionment. The translation is mathematically unsound if there exists a set of valid quantitative parameters that generates a correct simulation that does not correspond to any trajectory in the envisionment. More details of Modelica based qualitative analysis is described in “Qualitative reasoning with Modelica models” by Matthew Evans Klenk, Johan de Kleer, Daniel Bobrow, and Bill Janssen. Twenty-Eighth AAAI Conference on Artificial Intelligence, 2014 (hereinafter “[Klenk et al., 2014]”), which is hereby incorporated by reference.

Our ultimate goal is to integrate qualitative reasoning into the design process. We have shown how to do envisionment from Modelica models used in the many design contexts [Klenk et al., 2014] and how this technique fits into a design toolchain. In our current work on design exploration, qualitative reasoning eliminates component topologies that cannot meet the design requirements. See, e.g., “Using Modelica models for qualitative reasoning,” by Matthew Klenk, Johan de Kleer, and Bill Janssen (hereinafter “[Klenk et al., 2013]”), which is hereby incorporated by reference. Spurious states are qualitative states for which there are no quantitative solutions. Spurious states impact design because there exist topologies of components that qualitative simulation indicates meet the requirements, but for which there are no quantitative realizations and therefore cannot physically exist. While qualitative simulation may often include spurious states, reducing the number of spurious states and transitions is an active research problem for integrating qualitative reasoning into larger systems. See, e.g., “Checking qualitative reasoning with the conflict resolution algorithm” by John Maxwell, Johan de Kleer, and Matthew Klenk, in The 32nd Annual Workshop on Qualitative Reasoning (QR19), Macau, China, 2019 (hereinafter “[Maxwell et al., 2019]”)

In this disclosure, we adapt a recent advance in linear system solving, the conflict resolution method, for application in qualitative reasoning with the goal of reducing spurious states. In the following sections, we describe the problem, how we adapt the method for qualitative reasoning, and present examples of its execution with a limited analysis. The conflict resolution method is described in “Conflict resolution,” by Konstantin Korovin, Nestan Tsiskaridze, and Andrei Voronkov, in Proceedings of the 15th International Conference on Principles and Practice of Constraint Programming, CP′09, pages 509-523, Berlin, Heidelberg, 2009 (hereinafter “[Korovin et al., 2009]”).

Qualitative simulation of component-based models uses a qualitative algebra to specify constraints between variables and their derivatives. A qualitative algebra defines operations over qualitative values instead of quantitative values. For instance, Table 1 shows qualitative multiplication results. Similarly, Table 2 shows qualitative addition results.

TABLE 1
Qualitative multiplication

| * | Q− | Q0 | Q+ |
|---|---|---|---|
| Q− | Q+ | Q0 | Q− |
| Q0 | Q0 | Q0 | Q0 |
| Q+ | Q− | Q0 | Q+ |

TABLE 2
Qualitative addition

| + | Q− | Q0 | Q+ |
|---|---|---|---|
| Q− | Q− | Q− | ? |
| Q0 | Q− | Q0 | Q+ |
| Q+ | ? | Q+ | Q+ |

Notice that adding Q+ to Q− is undefined in Table 2, since the result can be any value (e.g., Q−, Q0, or Q+). Qualitative analysis typically propagates all three values through the constraints. But this ambiguity leads to spurious states. To see how problems can arise, consider the constraints:

x+y=z x+w=z (1)

Suppose that x and z are both Q+, and we want to assign values toy and w. If we look at the constraints individually in light of Table 2, then we see that y can have any value and that w can have any value. For example, y is Q+ and w is Q−. There are 9 possible value combinations for y and w. However, if we use variable substitution, we get y=w. So, we have an inconsistency since Q+ cannot be equal to Q−. With this constraint, only 3 of the 9 possible value combinations for y and w are valid.

One thread of qualitative reasoning research focuses on identifying extra constraints. As indicated in the example from the previous section, we can create a new constraint through substitution and use the following set of constraints.

x+y=z x+w=z y=w (2)

The second constraint is now redundant. In our previous work, we discussed how the equations identified by quantitative system modeling approaches are insufficient for qualitative reasoning [Klenk et al., 2014]. One way to solve this problem is to apply continuity and compatibility conditions (e.g., Kirchoff s voltage and current laws) repeatedly to deduce new constraints to add to the system. A common solution is to add one constraint for each planar window in a circuit.

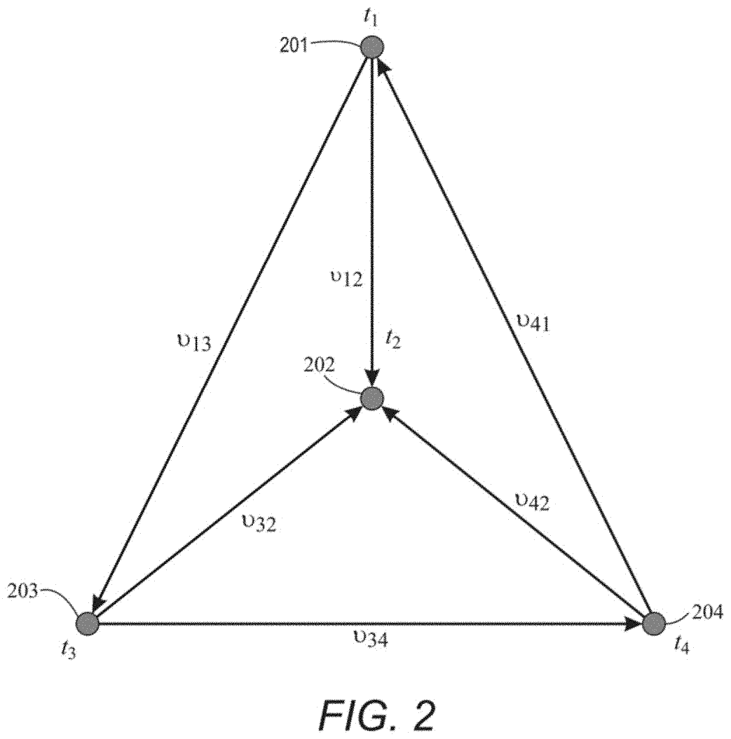

To see how this can still lead to spurious states, consider the circuit defined by (3), which is shown as a planar circuit in the diagram of FIG. 2. The circuit in FIG. 2 has three planar windows in it, defined by four terminals 201-204. Each edge represents a component the voltage across specified using with subscripts for the positive and negative connections (v₁₃ is the voltage between terminals 201 and 203), and voltages with respect to ground are specified at each terminal (t₁ is the voltage at the terminal 201).

t₁+v₁₂=t₂t₁+v₁₃=t₃t₃+v₃₂=t₂t₃+v₃₄=t₄t₄+v₄₁=t₁t₄+v₄₂=t₂ (3)

The Kirchoff s voltage law (KVL) constraints for these windows are shown in (4).

v₁₃+v₃₂−v₁₂=0v₃₄+v₄₂−v₃₂=0v₄₁+v₁₂−v₄₂=0 (4)

Now consider the value assignments in (5).

t₁=t₂=t₃=t₄=Q+v₁₃=v₃₄=v₄₁=Q−v₁₂=v₄₂=v₃₂=Q+ (5)

If we check these value assignments against the constraints we have, there are no inconsistencies (6). All of the assignments are valid according to qualitative addition.

t₁(Q+)+v₁₂(Q+)=t₂(Q+)t₁(Q+)+v₁₃(Q−)=t₃(Q+)t₃(Q+)+v₃₂(Q+)=t₂(Q+)t₃(Q+)+v₃₄(Q−)=t₄(Q+)t₄(Q+)+v₄₁(Q−)=t₁(Q+)t₄(Q+)+v₄₂(Q+)=t₂(Q+)t₄(Q+)+v₄₁(Q−)=t₁(Q+)v₁₃(Q−)+v₃₂(Q+)=v₁₂(Q+)v₃₄(Q−)+v₄₂(Q+)=v₃₂(Q+)v₄₁(Q−)+v₁₂(Q+)=v₄₂(Q+) (6)

However, this corresponds to a spurious state. If we create a KVL constraint for the outer loop of the planar circuit in FIG. 2 we get v₁₃+v₃₄+v₄₁=0. If we check the assignments against this constraint, we get an inconsistency (7).

v₁₃(Q−)+v₃₄(Q−)+v₄₁(Q−)=0 (7)

Adding every KVL constraint for a topology is in the worst case, exponential in the size of the topology. This motivates constructing only the additional constraints that eliminate spurious situations. Another approach to reducing spurious solutions is to integrate qualitative and quantitative algebraic reasoning [Williams, 1990; Williams, 1991] to eliminate inconsistencies. However, this approach requires a new complex algebraic simplifier and is not designed for use in an envisioner.

The Conflict Resolution Method (CRM) [Korovin et al., 2009] is a newer method for solving systems of linear inequalities that is an order of magnitude faster than the Fourier-Motzkin method. This result makes it promising for adaption to envisionment. Our envisioner follows from QSIM by generating new successor qualitative states from an initial state, e.g., using a branching time temporal logic behavior tree. The QSIM algorithms are described in “Qualitative reasoning: modeling and simulation with incomplete knowledge,” by Benjamin Kuipers, MIT press, 1994, which is incorporated herein by reference. We employ CRM as a final filter on each newly created qualitative state. If CRM identifies a conflict in the set of linear inequalities that represents the state, then it will not be added as a successor state.

CRM works by making a tentative assignment of values to variables, checking for inconsistencies, introducing new constraints based on the inconsistencies found, and iterating until all of the assignments are consistent or until a trivial inconsistency is found (e.g., 0>0). Therefore, our adaptation involves the model being specified as quantitative equations with parameters specified qualitatively.

To use CRM, we first assume that a qualitative reasoner has already checked that a given assignment of qualitative values to variables is consistent with the given set of constraints. Next, we convert the qualitative values into inequalities, so that v=Q+ becomes v>0, v=Q− becomes v<0, and v=Q0 becomes v=0. We then extract a subset of the original constraints that represent pure additions. Finally, we apply CRM to these inequalities along with the addition constraints. If CRM detects that the system of constraints reduces to a trivial inconsistency, then the assignment is invalid. Otherwise, the assignment is valid.

As an example, consider how this works with the constraints given by (1), repeated here as (8):

x+y=z x+w=z (8)

Given a qualitative state where x is Q+, y is Q+, z is Q+, and w is Q−. The qualitative reasoner doesn't detect an inconsistency in the qualitative additions involved. Now we convert the qualitative values to inequalities and add them to the constraints that we already have (9):

x+y=z x+w=z w<0x>0y>0z>0 (9)

CRM starts by ordering the variables, e.g., lexigraphically. Consider the order w, x, y, and z. It then associates each constraint with the variable in it that has the highest order. Thus, we associate w<0 with w, x>0 with x, y>0 with y, and x+y=z, x+w=z, and z>0 with z. It then starts with the lowest variable and tentatively assigns a quantitative value that is consistent with its constraints. The lowest ranked variable is w, and assigning w=−1 is consistent with w<0. There are no inconsistencies, therefore CRM goes on to the next variable. The next variable is x, and assigning x=1 is consistent with x>0. Since x has no inconsistencies, it goes to the next variable. The next variable is y, and assigning y=1 is consistent with y>0. Since y has no inconsistencies, it goes to the next variable.

At this point, we have assigned w=−1, x=1, and y=1, so x+y=z reduces to z=2 and x+w=z reduces to z=0. Notice that z=2 and z=0 are inconsistent. The method deals with this local inconsistency by creating a new constraint that is the combination of the constraints that produced the inconsistency. The new constraint is created by eliminating z from x+y=z and x+w=z. This produces x+y=x+w, which reduces toy=w. Now, the method associates this new constraint with the variable in it with the highest order, which is y. It then returns to y and processes it again.

The method processes y again with y>0 and y=w. Since we tentatively assigned w=−1, y=−1. But this is inconsistent with y>0. The method deals with this local inconsistency by combining y>0 and y=w to produce w>0. The method associates this new constraint with w and returns tow to process it again.

The method process w again with w<0 and w>0. This produces a local inconsistency. The method deals with this local inconsistency by combining w<0 and w>0 to produce 0>0. Since this is a trivial inconsistency, no solution is possible and (8) is globally inconsistent.

Notice that when the method deduced y=w from x+y=z and x+w=z, neither constraint depended on a variable assignment. Both constraints are always true, no matter what values are assigned to variables. This means that we can add y=w to the original constraints and use it with other assignments of values to values (e.g., y=Q− and w=Q+).

This speeds up CRM when checking other assignments to variables in later steps in the envisionment. Notice also that we did not need a full assignment of values to variables to detect the inconsistency. If we had left out x>0 and z>0 from the constraints, the method would have still found the inconsistency (it temporarily assigns x=0 if x had no constraints). This means that we can use CRM in cases where a system has variables that are under-constrained. In this case, we can leave the variables unspecified, and the envisioner will still function correctly.

While the above method will reduce the number of spurious qualitative states, it does require additional computation on each qualitative state. Therefore, we report some preliminary results as part of our work on automated design [Maxwell et al., 2019]. Envisioning a set of 22 seven component designs, we measure the total evaluation time and total number of qualitative states. Table 3 shows the results comparing qualitative simulation with and without conflict resolution algorithm in terms of envisionment size in qualitative states and computation time in seconds. Table 3 illustrates a 20% reduction in qualitative states with a 3% increase in computation time.

TABLE 3

| | Qualitative States | Time (seconds) |
|---|---|---|
| Baseline | 43,709 | 30 |
| With CRM | 35,069 | 31 |

We have shown that adding the Conflict Resolution Method provides a significant reduction in envisionment size while incurring minimal computational overhead. Although it takes time to run CRM, it also saves time, since some qualitative states get filtered early during envisionment reducing the number of states that must be expanded. The promise of this approach is that by eliminating spurious qualitative states, we will more effectively filter topologies qualitatively. Therefore, we need to assess the performance of CRM within the context of our conceptual design system.

Finally, the success of CRM suggests another approach to qualitative reasoning, which is to avoid qualitative algebras and to reason about regular algebras qualitatively instead. We did this here by converting constraints like v=Q+ into inequalities like v>0 and then applying a standard algorithm for reasoning over inequalities. We may be able to extend this approach to other operators in some situations.

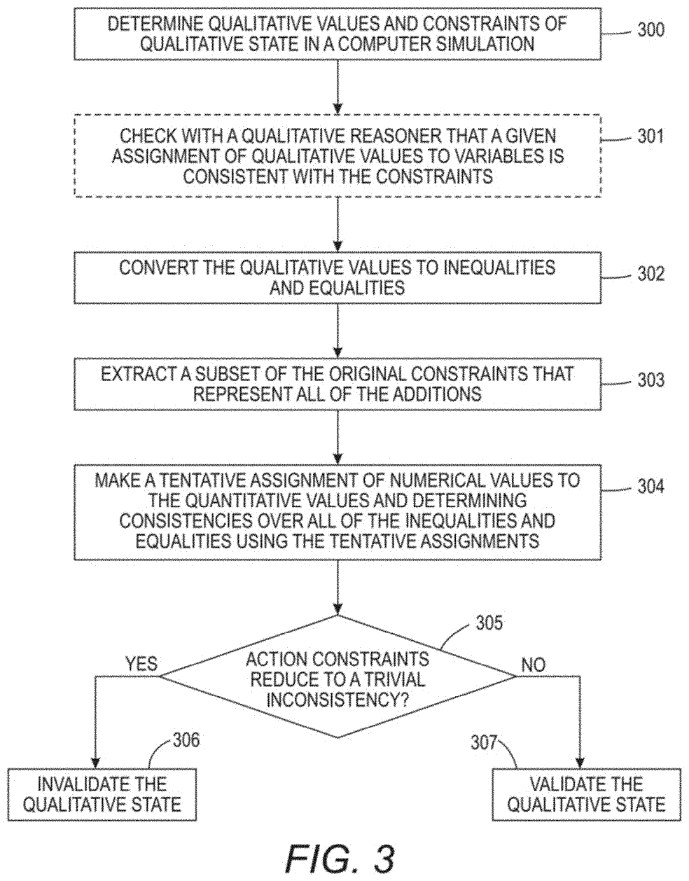

In FIG. 3, a flowchart illustrates a method according to an example embodiment. The method involves 300 determining qualitative values and constraints of a qualitative state in a computer simulation. At least some of the constraints include additions of at least some of the qualitative variables. A qualitative reasoner may optionally check 301 that a given assignment of qualitative values to variables is consistent with the constraints.

The qualitative values are converted 302 to inequalities and equalities, e.g., using numeric values that each correspond to one of the qualitative values. A subset of the original constraints that represent all of the additions are extracted 303, and CRM is applied to the inequalities along with the addition constraints. The conflict resolution method involves making 304 a tentative assignment of numerical values to the quantitative values and determining consistencies over all of the inequalities and equalities using the tentative assignments.

Based on the conflict resolution method determining that the addition constraints reduce to a trivial inconsistency (block 305 returns ‘yes’), the qualitative state is invalidated 306. Otherwise, if block 305 returns ‘no’ (meaning the addition constraints are consistent), the qualitative state is validated 307. Note that the process shown in FIG. 3 may be repeated for each of a plurality of states in a computer simulation, such that the invalidation 306 and invalidation 307 affect only one of the states evaluated.

The various embodiments described above may be implemented using circuitry, firmware, and/or software modules that interact to provide particular results. One who is skilled in the arts can readily implement such described functionality, either at a modular level or as a whole, using knowledge generally known in the art. For example, the flowcharts and control diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to provide the functions described hereinabove.

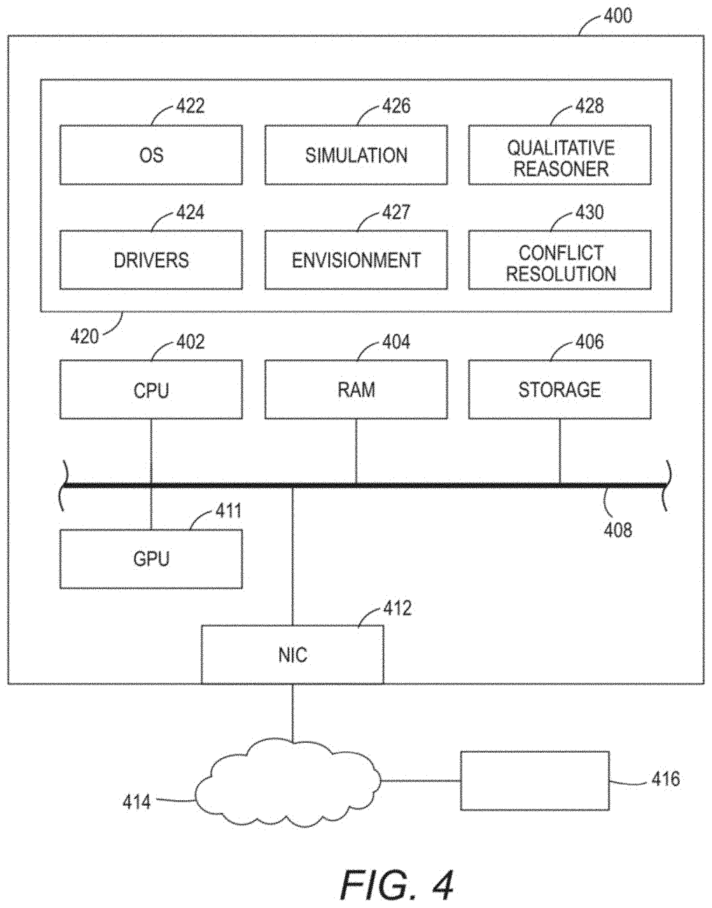

In FIG. 4, a block diagram shows an example of a computing apparatus 400 on which the embodiments described above may be implemented. The apparatus 400 includes one or more processors 402 such as a central processing unit, co-processor, digital signal processor, etc. The processor 402 is coupled to a data storage unit, which may include both random access memory 404 and persistent storage 406, via one or more input/output busses 408. Other general-purpose or special-purpose hardware may be coupled to the bus 408, such as graphics processing unit (GPU) 411 and network interface 412. Note that the functions of the apparatus 400 described below may be implemented via multiple devices, e.g., via client-server arrangement, clustered computing, cloud computing, etc. The network interface 412 facilitates communications via a network 414 with a network node 416, using wired or wireless media. The network node 416 may be a client, server, or peer of the apparatus, and may facilitate distributed computation.

The apparatus 400 includes software 420 that facilitates in the design of virtual or physical systems. The software 420 includes an operating system 422 and drivers 424 that facilitate communications between user-level programs and the hardware. The software 420 may also include a simulation program 426 that models and predicts performance of a system, e.g., mechanical, electrical, etc. A qualitative reasoner 428 is configured to represent variables and constraints of the models as qualitative values, and perform qualitative mathematics on them, e.g., algebra, calculus. The qualitative values and constraints are converted to a set inequalities and equalities that can be assigned numeric values by a conflict resolution solver 430 that determines inconsistencies in the set. When valid solutions and/or states are found, these can be presented via an envisionment component 427 that can represent the solutions/states to a user, e.g., graphically.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

1. A method comprising:
determining qualitative values and constraints of a qualitative state in a computer simulation, at least some of the constraints comprising additions of at least some of the qualitative values;
converting the qualitative values to inequalities and equalities;
extracting a subset of the original constraints that represents all of the additions;
applying a conflict resolution method to the inequalities along with the addition constraints, the conflict resolution method making a tentative assignment of numerical values to the quantitative values and determining consistencies over all of the inequalities and equalities using the tentative assignments; and
based on the conflict resolution method determining that the addition constraints reduce to a trivial inconsistency, invalidating the qualitative state.

2. The method of claim 1, further comprising, before converting the qualitative values to the inequalities and the equalities, checking with a qualitative reasoner that a given assignment of the qualitative values to variables is consistent with the constraints.

3. The method of claim 1, further comprising, based on CRM detecting that the addition constraints are consistent, validating the qualitative state.

4. The method of claim 1, wherein CRM comprises determining local inconsistencies that occur when making the tentative assignment of the numerical values, and for each of the local inconsistencies, repeatedly creating new constraints that are combinations of a subset of the addition constraints that produced each local inconsistency, until either the trivial inconsistency is found or a consistent solution for all of the addition constraints is found.

5. The method of claim 1, further comprising:
generating an initial qualitative state of the computer simulation; and
generating a plurality of successor quantitative states based on the initial quantitative state, wherein the qualitative values and the constraints are determined for each of the successor quantitative states and the conflict resolution method is applied as a filter on each of the successor states.

6. The method of claim 1, wherein the qualitative values and the constraints comprise an under determined system.

7. The method of claim 1, wherein the computer simulation provides an envisionment that represents a set of behaviors of the design space.

8. The method of claim 1, wherein the computer simulation comprises a Modelica model.

9. A computer readable medium storing instructions operable to cause a processor to perform the method of claim 1.

10. An apparatus, comprising:
a data input configured to receive parameters of a computer simulation; and
a processor coupled to the data input and configured to:
based on the parameters, determine qualitative values and constraints of a qualitative state in the computer simulation, at least some of the constraints comprising additions of at least some of the qualitative values;
convert the qualitative values to inequalities and equalities;
extract a subset of the original constraints that represents all of the additions;
apply CRM to the inequalities along with the addition constraints, the conflict resolution method making a tentative assignment of numerical values to the quantitative values and determining consistencies over all of the inequalities and equalities using the tentative assignments; and
based on the conflict resolution method determine that the addition constraints reduce to a trivial inconsistency, invalidating the qualitative state.

11. The apparatus of claim 10, wherein the processor is further configured to, before converting the qualitative values to the inequalities and the equalities, checking with a qualitative reasoner that a given assignment of the qualitative values to variables is consistent with the constraints.

12. The apparatus of claim 10, wherein the processor is further configured to, based on CRM detecting that the addition constraints are consistent, validate the qualitative state.

13. The apparatus of claim 10, wherein CRM comprises determining local inconsistencies that occur when making the tentative assignment of the numerical values, and for each of the local inconsistencies, repeatedly creating new constraints that are combinations of a subset of the addition constraints that produced each local inconsistency, until either the trivial inconsistency is found or a consistent solution for all of the addition constraints is found.

14. The apparatus of claim 10, wherein the processor is further configured to:
generate an initial qualitative state of the computer simulation; and
generate a plurality of successor quantitative states based on the initial quantitative state, wherein the qualitative values and the constraints are determined for each of the successor quantitative states and CRM is applied as a filter on each of the successor states.

15. The apparatus of claim 10, wherein the qualitative values and the constraints comprise an underdetermined system.

16. The apparatus of claim 10, wherein the computer simulation provides an envisionment that represents a set of behaviors of the design space.

17. The apparatus of claim 10, wherein the computer simulation comprises a Modelica model.
